(19) United States
(12) Patent Application Publication
(10) Pub. No.: US 2003/0088878 A1
(43) Pub. Date: May 8, 2003

(54) System and method for integration of high quality video multi-casting service with an interactive communication and information environment using internet protocols

(76) Inventors: Karl Rogers, Manhattan Beach, CA (US); Tim Evard, Indianapolis, IN (US)

Correspondence Address: Roberts Abokhair & Mardula, LLC, Suite 1000, 11800 Sunrise Valley Drive, Reston, VA, 20191-5302, US

(21) Appl. No.: 09/816,306

(22) Filed: Mar. 23, 2001

Related U.S. Application Data
(60) Provisional application No. 60/192,250, filed on Mar. 25, 2000.

(51) Int. Cl. H04N 7/173; H04N 7/16

(52) U.S. Cl. 725/109; 725/118; 725/135

(57) ABSTRACT

An efficient and effective system and method for the distribution of video and television broadcasts over the Internet in a multi-cast mode. A high-quality video multi-casting service is distributed, meaning that a single program is simultaneously sent to many individuals. The service also has an interactive communication and information environment associated with it, using the Internet protocol so that additional content can be viewed along with the video that is being received.

### CROSS REFERENCE TO RELATED APPLICATIONS

This application claims priority under 35 U.S.C. §119(e) from provisional application No. 60/192,250, filed Mar. 25, 2000. The No. 60/192,250 provisional application is incorporated by reference herein, in its entirety, for all purposes.

### INTRODUCTION

This invention relates generally to broadcasting of video over the Internet. More particularly, the present invention is a system and method for broadcasting multiple video channels together with other non-video content over a network, preferably the Internet, without a material adverse impact on bandwidth capability of the network.

### BACKGROUND OF THE INVENTION

Use of the Internet has been dramatically expanding, both domestically and internationally. Along with this dramatic expansion has come an increase in the requirements for the type of material being transmitted over the Internet. What was once the province of emails and document file transfers has now become one for interactive voice, telephony, and the desire for video transmission as well.

While cable operators have long been transmitting video quality programming over cable network, there has been an increased interest on the part of the public to receive video quality to PCs over the various Internet connections and networks that exist. The difficulty is that Internet protocols result in low video quality being presented to the Internet user. This is also coupled with very high utilization of bandwidth and high infrastructure costs. In short, the Internet is not designed to accommodate high quality broadcast of video services due to the inherent characteristics and architecture of the Internet, which were not designed with video in mind.

While the world wide web has become a very useful and flexible user tool for the dissemination of data, interactive operations and information services. This user interface has not been integrated well with broadcast audio and video content such as that found on television and available over radio stations. On the other hand, television has developed into the most widely used audio, visual medium in the world, yet interactivity and flexibility is not generally available for television broadcasting. Further, a flexible user interface for the Internet has not been integrated in any significant fashion into television broadcasts.

Currently, audio and video streaming sessions on the Internet are typically “uni-cast” or intended for a single user, although many “single users” may want video at the same time. Thus, when a user desires to obtain a streaming video session of a particular video or video clip, the user contacts the server having the stored program and that video or video clip is then fed to the single user over the Internet. As many users attempt to access the same video, it must be again individually broadcast to each individual user. Thus the volume of uni-casting of videos poses the potential for utilizing large amounts of bandwidth that might be available to others. This has an adverse impact on both the quality and the speed at which a video streaming session can be downloaded to an individual user. Further, the quality of not only the video itself but the quality of the service of the ISP suffers as huge amounts of bandwidth are utilized by such video transmission.

On-screen program guides and video-on-demand interfaces over television infrastructure are well known. However, these types of broadcasts have been limited to the television infrastructure. They have not been designed with a true Internet protocol multi-cast service in mind. Thus, the existing architectures for use in video-on-demand via the television infrastructure do not extend to the Internet infrastructure because of technical difficulties with the Internet itself.

What would be truly useful is to have an efficient and effective system and method for the distribution of video and television broadcasts over the Internet in a multi-cast mode. Such a distribution would be a high-quality video multi-casting service, meaning that a single program is simultaneously sent to many individuals. Such a service would also have an interactive communication and information environment associated with it, using the Internet protocol so that additional content can be viewed along with the video that is being received.

### SUMMARY OF THE INVENTION

It is therefore an object of the present invention to allow for high-quality video multi-casting of video programs.

It is yet another objective of the present invention to provide for interactive communication together with the multi-casting service.

It is a further objective of the present invention to allow for information to be provided using Internet protocols for display along with the high-quality video that is multi-casted.

It is yet another objective of the present invention to minimize the impact on the bandwidth of the Internet, yet still provide the multi-casting capability first noted above.

It a further objective of the present invention to provide for both live and/or stored multi-casting of video streams.

It is a further objective of the present invention to minimize the cost for creating an Internet architecture for video broadcasting.

It is yet another objective of the present invention to provide multi-casting on a broad band cable network.

It is a further objective of the present invention to provide television quality video, CD quality audio, online communication including chat and instant messaging, together with Internet content, commerce, and services.

It is yet another objective of the present invention to provide live and pre-recorded media presentations. It is a further objective of the present invention to provide for all of the above characteristics in a single interactive graphical user interface.

The architecture of the present invention supports high quality video streaming, while at the same time reducing bandwidth consumption over existing techniques. The video content including synchronized information is delivered from a national content center (NCC) to Regional Data Centers (RDC) for cacheing of content locally. This reduces traffic on the backbone system of distribution, which in the preferred embodiment, comprises both the Internet and cable TV networks. In addition, video streams may be transported live from a broadcast site or a National Content Center to regional centers for subsequent redistribution. Video streams are multi-cast, using Internet Group Management Protocol (IGMP) and class D addressing with private multi-cast addresses. Router configurations and routing policies are controlled between the video server and the cable modem to allow true multi-cast to occur. This reduces traffic on the network by dramatically reducing the number of video content streams from that of a uni-cast system which otherwise would be providing an individual video stream to each individual user.

Several mechanisms support the transportation of the video content to Regional Data Centers from where it is multi-cast to subscribers. Any video information that is archived is sent to a cache memory at the servers at the Regional Data Centers. In addition, other media servers may exist across the backbone communication system. Since such archived video information is not in real time, it can be sent during off peak hours so that it does not disturb other traffic on the network, nor absorb a disproportionate amount of bandwidth, and thereby decrease the performance of the network.

For those broadcasts which are to be done in real time, the content is sent in real time over the backbone of the network to regional distribution centers. The regional distribution centers subsequently distribute the video in a multi-cast mode to subscribers. Redundant servers and routers ensure that broadcasts are uninterrupted.

As noted earlier, the regional distribution centers can either store the video to be distributed, or take the single stream coming over the backbone and re-broadcast it in a multi-cast mode to its individual customers.

When the system of the present invention is transmitting a live broadcast, a translator/multiplexer in the Regional Data Center receives the live broadcast content and converts it from the “broadcast” transport format to a multi-cast IP streaming format encoded, addressed, and associated with the necessary protocols for multi-cast in the local/regional network. Using this same architecture, archived content from cached servers having previously stored the live broadcast content, can also be multi-cast from the Regional Data Center to other servers or directly to individual subscribers.

The video screen that displays the multi-cast video also displays data on the video screen that is directly related to the video being shown. This additional content is displayed at the appropriate time and with direct relationship to the video program in question.

The video screen which provides a graphical user interface for a particular user incorporate various “buttons” that can provide information associated with the objects in the video stream. In addition, to the extent that the multi cast is not a real time video feed, there will also be video control buttons such as stop, play, pause, or screen size manipulation.

In addition this system of the present invention provides for imbedding of commercial advertisements and sponsor information into the video multi cast Internet protocol streams similar to those commercials that occur in a normal television broadcast.

An aspect of the present invention that is not found in typical television is the potential for user interactivity and information content such as chat capability or messaging without multi-cast subscribers. Further a provision is made for opinion polls, and parental controls or other text based information associated with video programming.

The information that is available on the user screen, especially that information which is interactive in nature, is synchronized with the associated choice of channel or video programming. Thus when a particular video is being shown, information that is relevant to that video or the subject matter of the video will also be displayed for the user.

An interactive program guide allows a user to change channels using a single mouse click. This program guide can be scaled between a full program guide or a quick view summary.

Thus the present invention provides for a high degree of integration of programming, program guide, information, and other communications then existing uni-cast services. Further the present invention provides for interactivity with a video broadcast in much the same way that interactivity now exists on the Internet. Thus the system allows for the delivery of television like content over the Internet while controlling the parameters that affect video quality such as latency, jitter and packet loss. Finally, the present invention as configured reduces the number of individual streams necessary to access the video content.

This information will be further understood by the detailed description of the invention that follows.

### BRIEF DESCRIPTION OF THE DRAWINGS

FIG. 1 illustrates prior art for distribution of video over the Internet.

FIG. 2 illustrates the system architecture of the present invention.

FIG. 2A illustrates the National Content Center architecture.

FIG. 2B illustrates a broadcast network of the present invention.

FIG. 2C illustrates the Regional Data Center.

FIG. 3 illustrates the graphical user interface of the present invention.

FIG. 4 illustrates the movie controls of the present invention.

FIG. 5 illustrates the viewer participation region of the PCTV interface.

FIG. 6 illustrates the promotional/sponsor area of the PCTV screen.

FIG. 7 illustrates the program guide portion of the PCTV screen.

FIG. 8 illustrates the “channel ticker” portion the PCTV screen.

FIG. 9 illustrates the multi-cast stream of the present invention.

### DETAILED DESCRIPTION

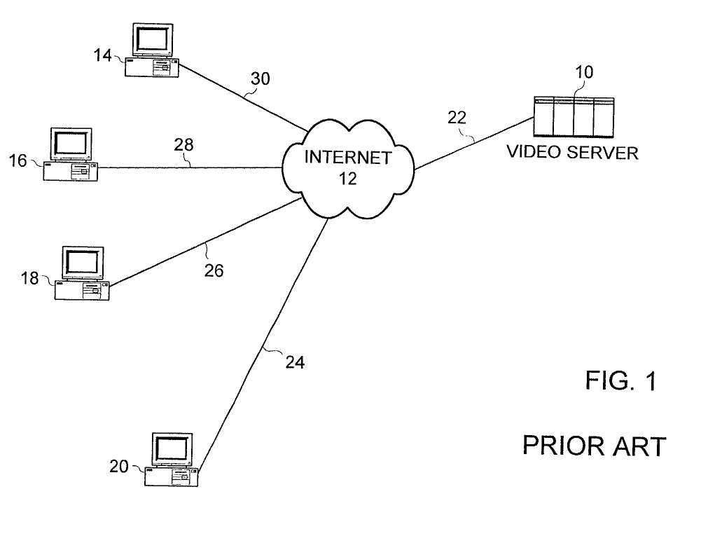

Referring first to FIG. 1, the prior art for distribution of video over the Internet is illustrated. When an individual user 14 desires to view a particular video broadcast, a request is made over link 30 over the Internet 12 to a particular host 10 which is connected to the Internet over link 22. The video requested is then streamed to user 14 over link 22 over the Internet 12, over link 30 to user 14. The difficulty occurs when users 16, 18, and 20 each desire to view the same or another video. Each user accesses the Internet over its respective link 24, 26, and 28 over Internet 12 to host 10 over link 22. Host 10 must then download, most probably at different times, the video desired over link 22. Thus the traffic over link 22 is repeated at slightly different times even though the same video is being downloaded. This uni-cast mode takes a tremendous amount of bandwidth over link 22, thereby degrading the performance of the Internet service provider which is offering link 22 and the associated connection to the Internet. This problem is especially compounded when the video feed is in real time, wherein users 14, 16, 18, and 20 all desire the same video feed at the same time. This leads to a significant degradation in performance of link 22, and any associated equipment.

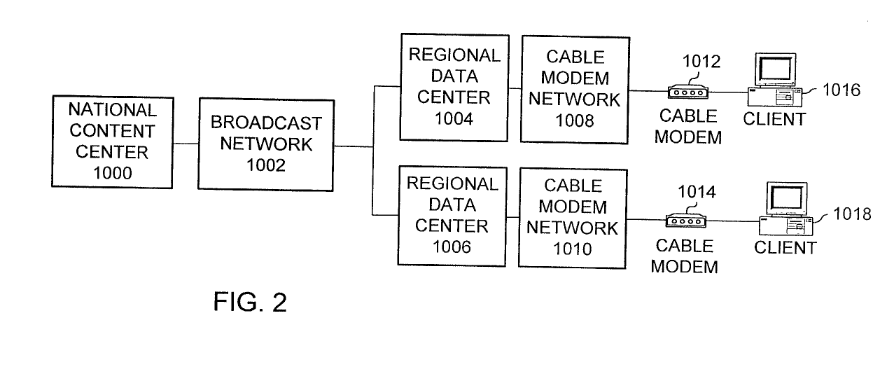

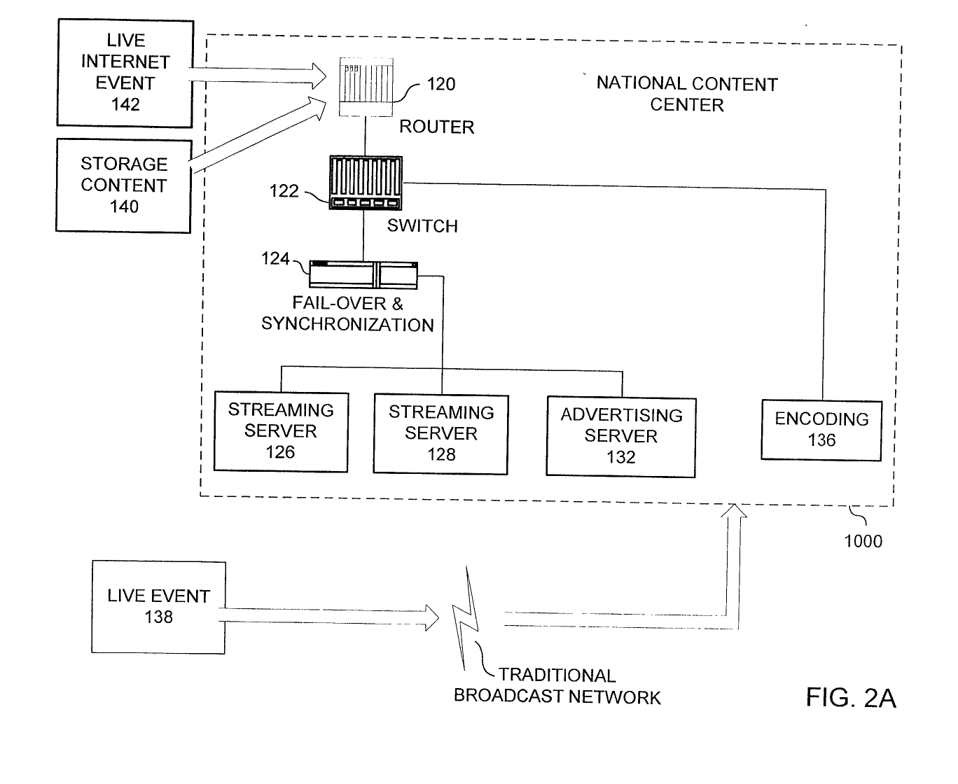

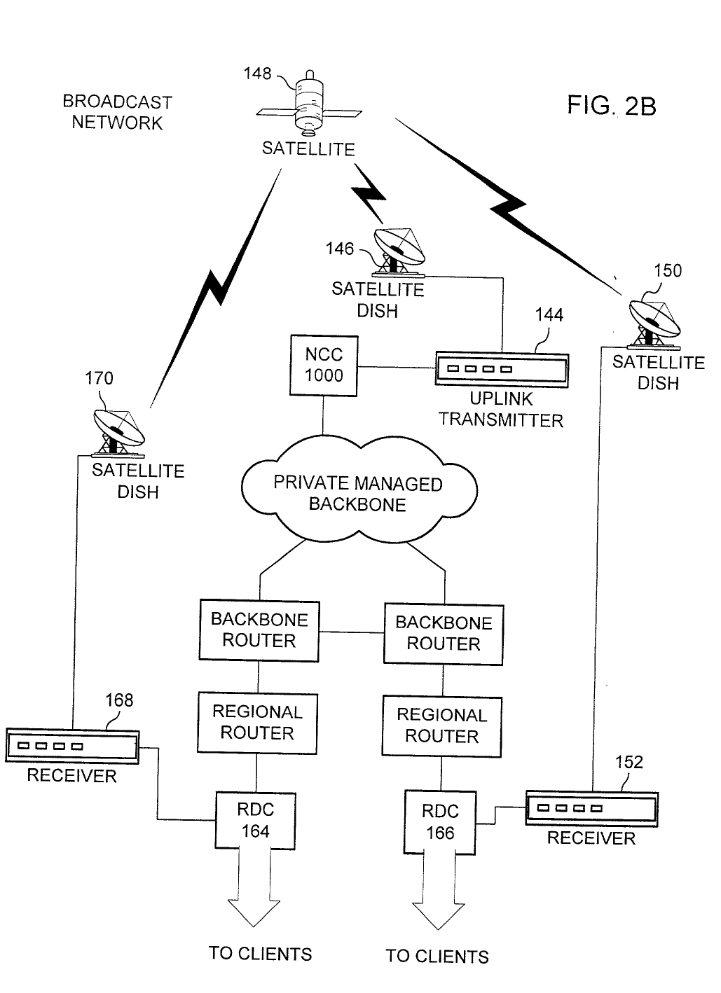

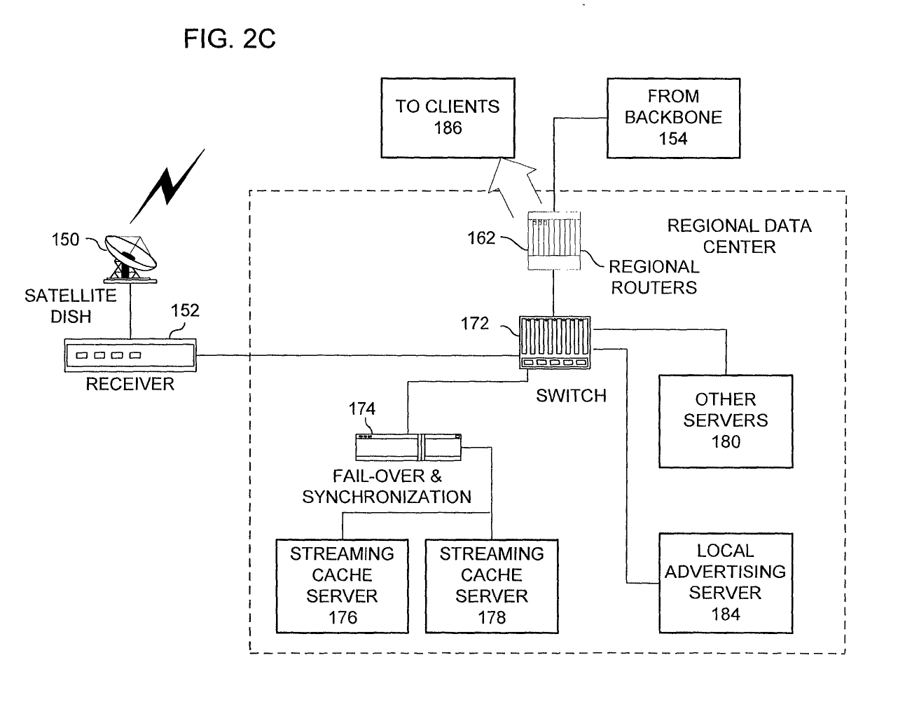

Referring to FIG. 2, the system architecture of the present invention is illustrated. A National Content Center 1000, which receives and distributes content over the total network, is connected to a broadcast network 1002. The broadcast network can be a cable modem network, satellite network, or any other type of wired or wireless network for the distribution of content on a national level. Regional Data Centers 1004 and 1006 are connected to the broadcast network 1002. each Regional Data Center distributes content to its particular region. This may be a multi-state region, or some other region for which the data center has primary responsibility. Each Regional Data Center is in turn connected to a cable modem network 1010, 1008 where content is typically distributed in ways known in the art. These cable modem networks 1010, 1008 are the normal cable networks that are currently available for distribution of video to homes. Each cable modem network is in turn connected in the individual home to cable modems 1012 and 1014. Individual client PCs 1016 and 1018 are connected to cable modems 1014 and 1012 respectively to receive information from and interact over a network for various purposes.

In this instance, however, video-like broadcasts are sent over this entire network so that individual clients 1016 and 1018 can receive video and digital video transmissions directly on their PCs.

Referring to FIG. 2A, the National Content Center 1000 architecture is further illustrated. The National Content Center comprises a series of servers for providing the content, advertising, and other information and features that are transmitted to the Regional Data Centers, and also comprises appropriate switches and routers for providing that information over the broadcast network.

The National Content Center provides both live and previously stored content over a backbone network to Regional Data Centers. To provide this service, the National Content Center 1000 comprises streaming servers 126 and 128 which are redundant in nature. Any content that is to be “streamed” that is, provided continuously over the network, must be reliably broadcast. Hence, streaming servers 126 and 128 provide precisely the same content and hence, provide for redundancy in the event of the failure of any one of the servers 126, 128. The servers are synchronized in their broadcast by a synchronizer 124 which compares timing and other indicators in the broadcast from the two streaming servers 126 and 128, and ensures that they are precisely synchronized. Therefore in the event of a failure of either one of the servers, there will an uninterrupted broadcast to the ultimate customers.

The streaming content is then provided through switch 122 through router 120 and over the broadcast network (FIG. 2, 102).

The National Content Center 1000 also comprises a content manager 130 which is a server that manages other content that is transmitted along with any video that is transmitted. Content manager 130 comprises information that is related to the video that is being broadcast and allows users to link to other sites and other information that is of interest.

The National Content Center 1000 also comprises an advertising server 132 that provides advertising that is to accompany the other broadcasts from the National Content Center 1000. Thus, national advertising can be submitted to go along with certain broadcasts while still allowing local advertising to be served by other Regional Data Centers (FIG. 2, 104, 106). The National Content Center 1000 also comprises a publishing server 134 which provides yet additional content and other related information that has a direct relationship to the information that is being transmitted by steaming servers 126 and 128.

In the case where a live event 138 is to be broadcast and carried by the system of the present invention, the live event 138 is broadcast in a traditional fashion and is encoded by encoding server 136 with the National Content Center 1000. This continuously fed encoded signal is then provided to switch 122 and then is transmitted over a router 120. All additional content, advertising, and publishing which might be presented by content manager 130, advertising server 132, and publishing server 134 can continue to accompany the live event as it is broadcast.

The system of the present invention also can allow live Internet events 142 to be broadcast via router 120. This information can be live chat rooms, live presentations and interactions of all different kinds. Further, previously recorded and stored content 140 can be transmitted as well via the router 120 from the National Content Center 1000.

Referring now to FIG. 2B, a broadcast network of the present invention is illustrated. National Content Center 1000 can optimally transmit in two fashions. First, its content can be transmitted to an uplink transmitter 144 for subsequent transmission by satellite dish 146 to a distribution satellite 148. Thereafter the transmission can be received by Regional Data Centers via a Regional Data Center satellite dish 150 and associated receiver 152. The transmission can then proceed to the Regional Data Center 166. Similarly other Regional Data Centers 164 will have their own associated receivers 168 and satellite dishes 170 for receipt of transmissions from satellite 148. All such transmissions will be accompanied by information from the publishing server, advertising server, content manager, and other information as appropriate from the National Content Center.

The NCC 1000 also has the option of transmitting over the privately managed backbone 154. This backbone may be an Intranet, a cable network, or indeed any other network that can be privately managed and administered by an entity running the NCC 1000. Redundant backbone routers 156 and 158 provide appropriate routing to various regional data centers. The backbone routers are linked and are redundant such that in the event of the failure of one router, the second router can continue to broadcast the content from NCC 1000. It should also be noted that, while two backbone routers 156 and 158 are illustrated, this is not meant as a limitation. Any number of backbone routers can be used to simultaneously transmit the content from NCC 1000 over the privately managed backbone 154. Thus, the illustration of backbone routers 156 and 158 are for illustrative purposes only, and are not meant as a limitation.

Content that is broadcast from the NCC is received by each Regional Data Center 164, 166 via associated regional routers 160, 162. Thereafter, any content is subsequently rebroadcast by the Regional Data Centers 164, 166 to their respective clients. Again the two regional data centers 164, 166 illustrated in this figure are for illustrative purposes only and are not meant as a limitation. Many Regional Data Centers may exist and will be able to broadcast the content that is broadcast from the NCC to their respective clients.

Referring now to FIG. 2C, the Regional Data Center 166 is illustrated. For purposes of this figure, only one Regional Data Center is discussed, although each Regional Data Center will have similar architectures. Regional Data 166 receives its transmission via the backbone 154 through its regional router 162 to the Regional Data switch 172. Alternatively, the Regional Data 166 can receive its transmission via its satellite dish 150 through its receiver 152 and then to Regional Data Center switch 172.

The structure of the Regional Data Center is similar in certain respects to that of the National Content Center. For example, streaming cash servers 176, 178 are redundant cash servers which stream information and content to clients 186. A synchronizer 174 keeps the streaming cash servers 176, 178 in synchronization. Therefore, if any one streaming cash server fails, the second server will continue to provide the streaming product to clients via the synchronizer 174. Publishing server 180 works in concert with content manager 186 to provide additional content and information on the screens of the clients 186 as the streaming content is provided to the PCs of clients. In this fashion, and as more fully described below, additional content can be viewed by clients. Publishing server 180, content manager 186, and any other servers 182 all provide their content via switch 172 to be accompanied by the streaming content from streaming cash servers 176, 178.

Each Regional Data Center also has a local advertising server 184 to provide local advertising content that is sold by the Regional Data Center, and which accompanies the content and other streaming transmissions from the Regional Data Center.

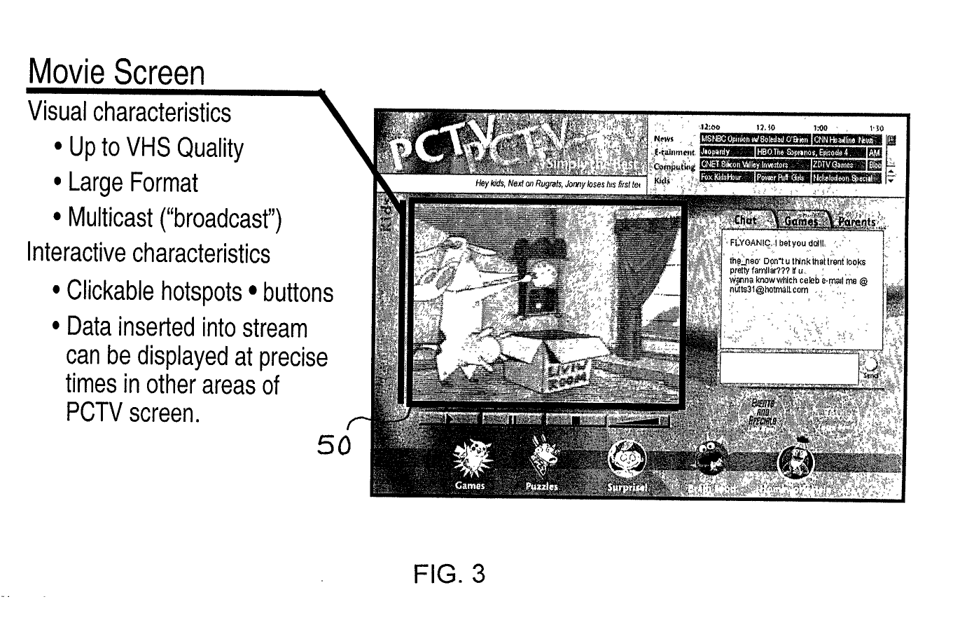

Referring to FIG. 3, the graphical user interface of the present invention is illustrated. FIG. 3 illustrates certain characteristics associated with the video screen itself. In this illustration, a portion of the display is devoted to a video screen 50 that comprises the movie content desired by a user. Image quality is up to VHS quality in a large format. Further, the video is multi-cast to multiple users at the same time. The image further comprises clickable hot spots within the video screen portion where a user can click and obtain additional information or displays. Further, data can be inserted into the video screen and be displayed at precise times in other areas of the PCTV screen.

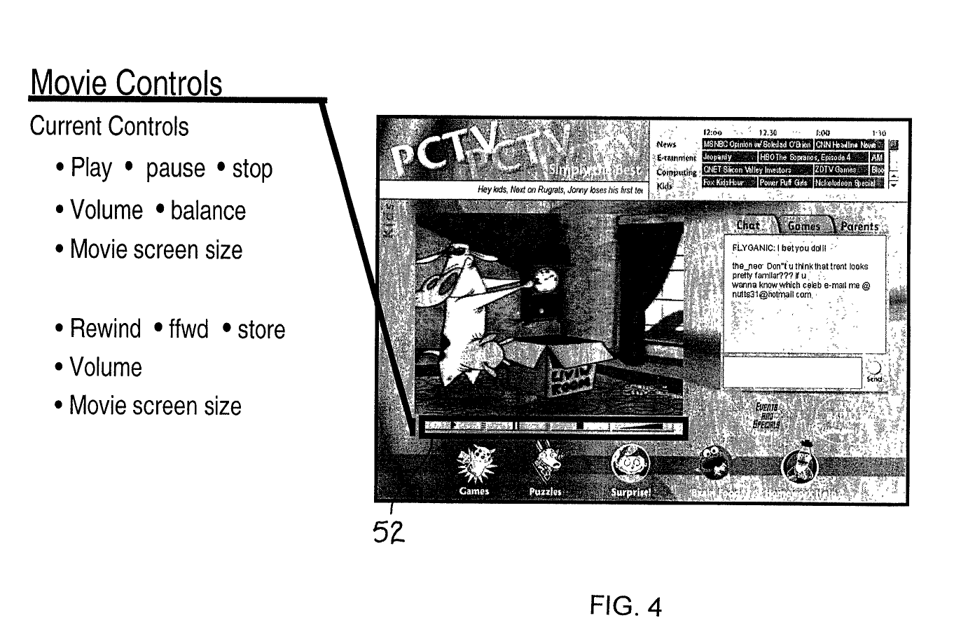

Referring to FIG. 4, the movie controls of the present invention are illustrated. Movie controls 52 allow for the movie to be played, to pause, to stop, and to adjust volume, balance, and movie screen size. Further, controls allow for rewind, fast forward, storing of images, volume control. All of these control instructions are exercised by the user via a mouse click which sends the appropriate signal to the Regional Data Center for adjustment of the stream for that particular individual.

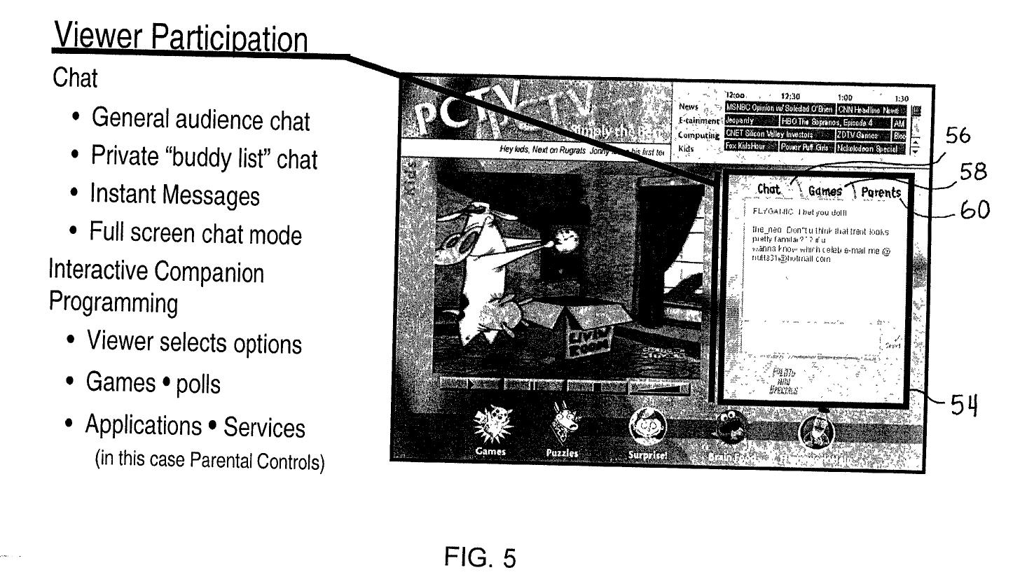

Referring to FIG. 5, the viewer participation region of the PCTV interface is illustrated. In this instance, the user is given a portion of the screen comprising tabbed areas, each of which could be clicked on by a user to gain access to different yet relevant activities. For example, by clicking on the “chat” tab, the user can be taken to a site that provides general audience chat, private “buddy list” chat, instant messages, or a full screen chat mode. The chat room that is accessed is keyed to the video presentation in progress.

By clicking on the “games” tab 58, the user is taken to a screen where games that are relevant to the video being displayed can be played. Finally, a parental controls tab 60 can also be clicked to allow parental controls such as those known in the art to be imposed on any such viewing.

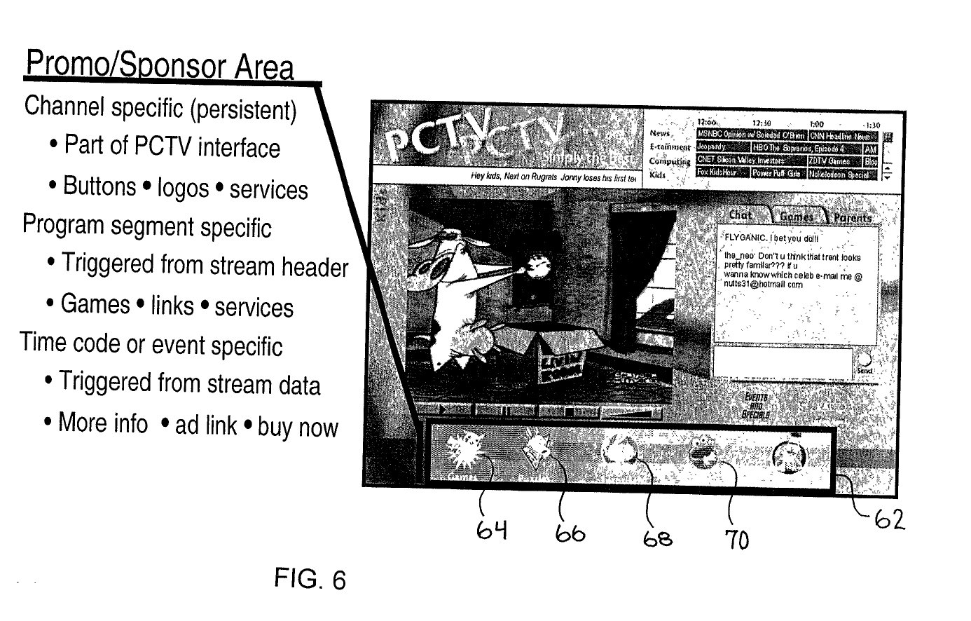

Referring to FIG. 6, the promotional/sponsor area of the PCTV screen is illustrated. In this area, certain clickable areas exist, which comprise buttons and logos that relate to goods and services for sponsors. Thus, for example, if a cartoon is playing and that cartoon is related to Nickelodeon® a button will also exist to click on which will take the user to Nickelodeon® related products.

The buttons and clickable areas for the promotional/sponsor area are program segment specific. These vary from program to program and are triggered by the video stream header. They comprise games, links, and services, all of which are directly related to the video stream being viewed. In addition, advertisements will also be keyed to the video that is being viewed. Thus if a particular cartoon character, for example, is on screen, a product can also be offered that features that particular cartoon character, thereby further encouraging the purchase. In addition, games button 64, puzzles button 66, surprise button 68, and additional button 70, all of which are presented for illustrative purposes only and are not meant as a limitation, will all present subject matter that is relevant to the particular video being displayed.

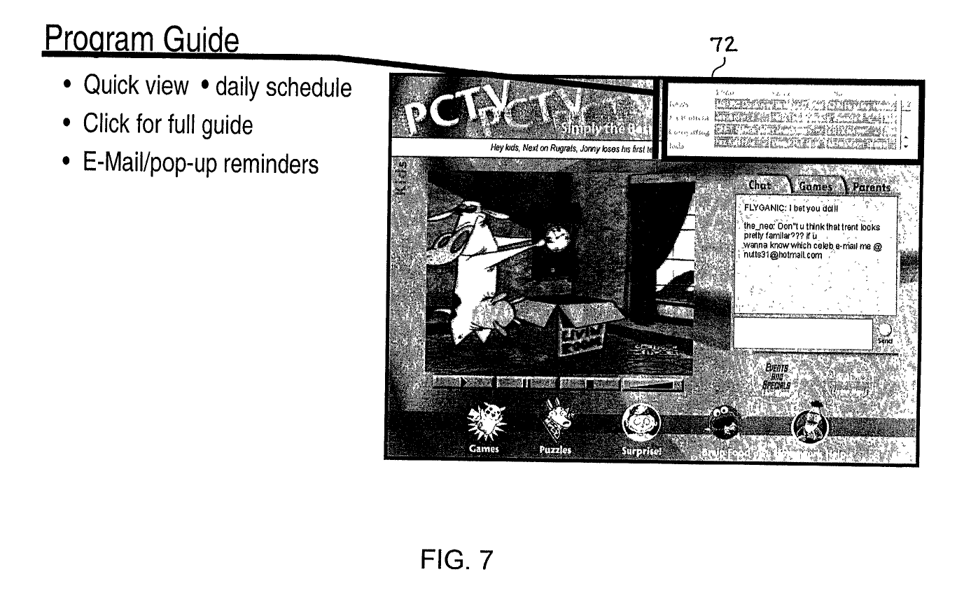

Referring to FIG. 7, the program guide portion of the PCTV screen is illustrated. The program guide provides for a quick view of the daily schedule on the various channels that are offered over the PCTV. Clicking on any particular segment of the program guide brings up that particular portion of the video that is available at that time and on that date. In addition, email reminders can be scheduled so that a particular program is not missed.

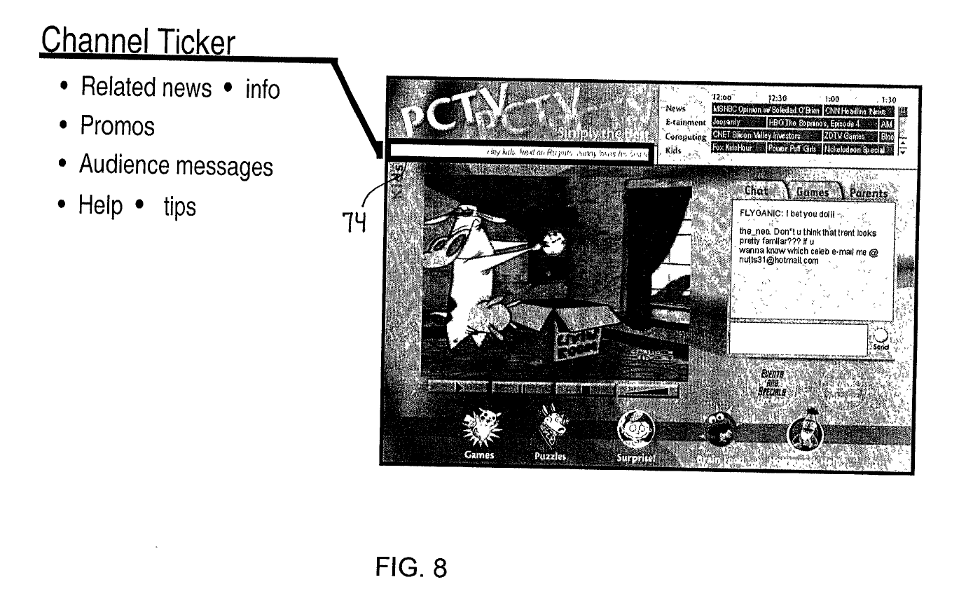

Referring to FIG. 8, the “channel ticker” portion the PCTV screen is illustrated. This portion allows a continuous stream of information to be presented to viewers regarding related news, information, promotional items, audience messages, helpful information, and related tips. Again this information is directly related to the video that is being shown, although this is not meant as a limitation.

Thus, PCTV of the present invention provides high-quality video and audio programming over Internet and cable to a personal computer. It further provides communication capability by permitting live question and answer, audience chat, buddy list chat and instant messaging during the course of presentation of video and audio programming. As such, the present invention offers interactivity which is not now offered with current television programming. These above capabilities are integrated with electronic commerce activity such as sales of merchandise and services. Further, the system of the present invention allows for advertising, sponsorships, and web content, all of which is keyed to the video and audio being displayed.

The file of this patent contains at least one drawing executed in color. Copies of this patent with color drawing(s) will be provide by the Patent and Trademark Office upon request and payment of the necessary fee.

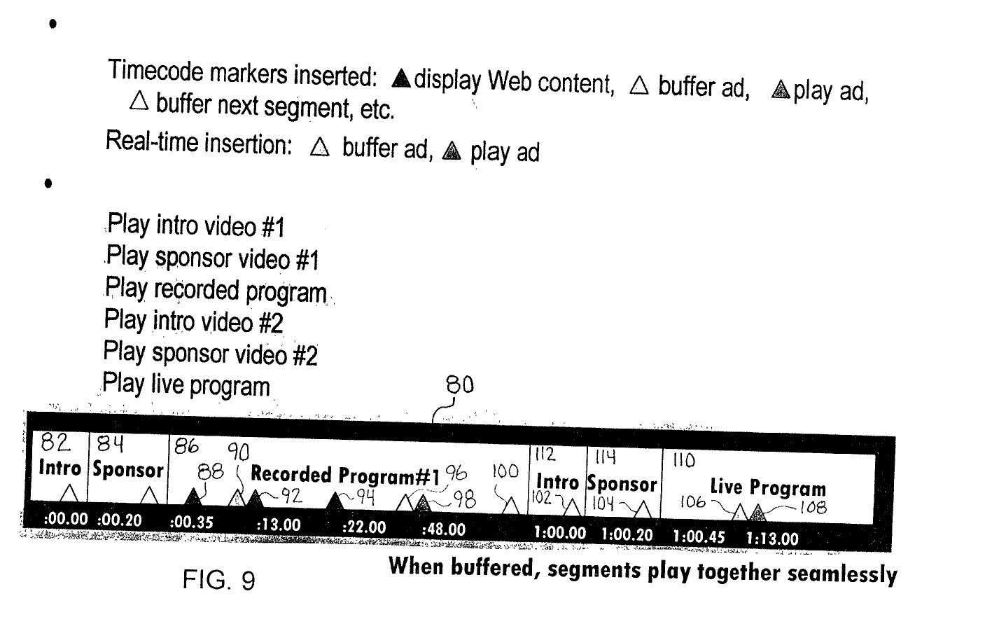

Referring to FIG. 9, the multi-cast stream of the present invention is illustrated. Using the present invention, video segments are encoded and indexed. Time code markers are inserted for the display of web content, to buffer an ad to be displayed, to play an ad, and to buffer the next segment. Referring to the timing strip 80, a typical series of events is illustrated. Initially, an introductory screen 82 is played on the users video screen. This is followed by a sponsorship message 84. The pre-recorded program 86 is then played for a period of time. The key aspect of the present invention however, is the fact that additional web content and other inserts may be presented on the PCTV screen at the same time that the recorded program 86 is being played. Thus for example, at time slot 88, a particular web content is displayed which is keyed to the recorded program. At time slot 90, an advertisement is placed in a buffer for subsequent display. At time slot 92, the advertisement that has been buffered is played. At time slot 94, additional web content in another part of the PCTV screen is displayed. At time slot 96, another advertisement is buffered. At time slot 98, the buffered advertisement is played. At time slot 100, additional material is played in another part of the screen.

Subsequently during other programming, an introduction 112 is played followed by a sponsorship message 114, and then followed by a live program 110. During the live programming, advertisements can again be buffered and played in other parts of the screen. The content of these additional ads and information are all directly relevant to the video being shown.

A system and method for integration of high-quality video and multi-casting servers with an interactive communication and information environment using Internet protocols has now been illustrated. It will be appreciated by those skilled in the art that other embodiments of the present invention are possible without departing from the scope of the invention as disclosed.

What is claimed is:

1. A method for multi-casting video content to plural user computers, the method comprising:
distributing a video content program from a content center to plural regional data centers via an open network;
distributing the video content program from each of the plural regional data centers to user computers network connected to the plural regional data centers according to a multi-cast protocol; and
transmitting non-video data related to the video content program to the user computers for display by the computer contemporaneously with the video content program.
